(19) United States
(12) Patent Application Publication
(10) Pub. No.: US 2003/0170148 A1
(43) Pub. Date: Sep. 11, 2003

(54) Reaction chamber roll pump

(76) Inventors: John F. McEntee, Boulder Creek, CA (US); Jay K. Bass, Mountain View, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/379,959

(22) Filed: Mar. 4, 2003

Related U.S. Application Data
(63) Continuation-in-part of application No. 09/775,012, filed on Jan. 31, 2001.
(63) Continuation-in-part of application No. 10/287,338, filed on Nov. 4, 2002.
(63) Continuation-in-part of application No. 09/775,375, filed on Jan. 31, 2001.

(51) Int. Cl. B32B 5/02; B32B 27/04; B32B 27/12

(52) U.S. Cl. 422/102

(57) ABSTRACT

A method and system for packaging microarrays, including a microarray package and reaction chamber adapted to a roll-pump application, the microarray package and reaction chamber comprising a pocket, a microarray positioned to substantially cover the pocket, and a flexible cover sealed to the pocket to enclose the microarray in an enclosed package and reaction chamber. The active surface of the microarray, on which features have been deposited, faces into the pocket. In an alternative embodiment, the microarray is positioned active-side down within a reaction chamber with a substantially greater volume than that of reaction fluid introduced into the reaction chamber, and the reaction chamber is rotated so that reaction fluid repeatedly flows across the active surface of the microarray.

### CROSS-REFERENCES TO RELATED APPLICATION

This application is a continuation-in-part of U.S. application Ser. Nos. 09/775,012, filed Jan. 30, 2001, 10/287,338, filed Nov. 4, 2002, and 09/775,375, filed Jan. 31, 2001, now pending, which are incorporated herein by reference.

### TECHNICAL FIELD

The present invention relates to small reaction chambers, such as a reaction chamber including a microarray within a microarray strip, and, in particular, to a method and system for circulating solutions within small sealed reaction chambers.

### BACKGROUND OF THE INVENTION

Microarrays are widely used and increasingly important tools for rapid hybridization analysis of sample solutions against hundreds or thousands of precisely ordered and positioned features on the active surfaces of microarrays that contain different types of molecules. Microarrays are normally prepared by synthesizing or attaching a large number of molecular species to a chemically prepared substrate such as silicone, glass, or plastic. Each feature, or element, on the active surface of the microarray is defined to be a small, regularly-shaped region on the surface of the substrate. The features are arranged in a regular pattern. Each feature may contain a different molecular species, and the molecular species within a given feature may differ from the molecular species within the remaining features of the microarray. In one type of hybridization experiment, a sample solution containing radioactively, fluorescently, or chemoluminescently labeled molecules is applied to the active surface of the microarray. Certain of the labeled molecules in the sample solution may specifically bind to, or hybridize with, one or more of the different molecular species in one or more features of the microarray. Following hybridization, the sample solution is removed by washing the surface of the microarray with a buffer solution, and the microarray is then analyzed by radiometric or optical methods to determine to which specific features of the microarray the labeled molecules are bound. Thus, in a single experiment, a solution of labeled molecules can be screened for binding to hundreds or thousands of different molecular species that together compose the microarray. Microarrays commonly contain oligonucleotides or complementary deoxyribonucleic molecules to which labeled deoxyribonucleic acid and ribonucleic acid molecules bind via sequence-specific hybridization.

Generally, radiometric or optical analysis of the microarray produces a scanned image consisting of a two-dimensional matrix, or grid, of pixels, each pixel having one or more intensity values corresponding to one or more signals. Scanned images are commonly produced electronically by optical or radiometric scanners and the resulting two-dimensional matrix of pixels is stored in computer memory or on a non-volatile storage device. Alternatively, analog methods of analysis, such as photography, can be used to produce continuous images of a microarray that can be then digitized by a scanning device and stored in computer memory or in a computer storage device.

The ability to denature and renature double-stranded deoxyribonucleic acid (“DNA”) and ribonucleic acid (“RNA”) has led to the development of many extremely powerful and discriminating assay technologies for identifying the presence of DNA and RNA polymers having particular base sequences or containing particular base subsequences within complex mixtures of different nucleic acid polymers, other biopolymers, and inorganic and organic chemical compounds. One such methodology is the array-based hybridization assay. An array comprises a substrate upon which a regular pattern of features is prepared by various manufacturing processes. Each feature of the array contains a large number of identical oligonucleotides covalently bound to the surface of the feature. These bound oligonucleotides are known as probes. In general, chemically distinct probes are bound to the different features of an array, so that each feature corresponds to a particular nucleotide sequence.

Once an array has been prepared, the array may be exposed to a sample solution of target DNA or RNA molecules labeled with fluorophores, chemiluminescent compounds, or radioactive atoms. Labeled target DNA or RNA hybridizes through base pairing interactions to the complementary probe DNA, synthesized on the surface of the array. Targets that do not contains nucleotide sequences complementary to any of the probes bound to array surface do not hybridize to generate stable duplexes and, as a result, tend to remain in solution. The sample solution is then rinsed from the surface of the array, washing away any unbound-labeled DNA molecules. In other embodiments, unlabeled target sample is allowed to hybridize with the array first. Typically, such a target sample has been modified with a chemical moiety that will react with a second chemical moiety in subsequent steps. Then, either before or after a wash step, a solution containing the second chemical moiety bound to a label is reacted with the target on the array. After washing, the array is ready for scanning. Biotin and avidin represent an example of a pair of chemical moieties that can be utilized for such steps.

Finally, the bound labeled DNA molecules are detected via optical or radiometric scanning. Optical scanning involves exciting labels of bound labeled DNA molecules with electromagnetic radiation of appropriate frequency and detecting fluorescent emissions from the labels, or detecting light emitted from chemiluminescent labels. When radioisotope labels are employed, radiometric scanning can be used to detect the signal emitted from the hybridized features. Additional types of signals are also possible, including electrical signals generated by electrical properties of bound target molecules, magnetic properties of bound target molecules, and other such physical properties of bound target molecules that can produce a detectable signal. Optical, radiometric, or other types of scanning produce an analog or digital representation of the array, with features to which labeled target molecules are hybridized optically or digitally differentiated from those features to which no labeled DNA molecules are bound. In other words, the analog or digital representation of a scanned array displays positive signals for features to which labeled DNA molecules are hybridized and displays negative features to which no, or an undetectably small number of, labeled DNA molecules are bound. Features displaying positive signals in the analog or digital representation indicate the presence of DNA molecules with complementary nucleotide sequences in the original sample solution. Moreover, the signal intensity produced by a feature is generally related to the amount of labeled DNA bound to the feature, in turn related to the concentration, in the sample to which the array was exposed, of labeled DNA complementary to the oligonucleotide within the feature.

One, two, or more than two data subsets within a data set can be obtained from a single molecular array by scanning the molecular array for one, two or more than two types of signals. Two or more data subsets can also be obtained by combining data from two different arrays. When optical scanning is used to detect fluorescent or chemiluminescent emission from chromophore labels, a first set of signals, or data subset, may be generated by scanning the molecular array at a first optical wavelength, a second set of signals, or data subset, may be generated by scanning the molecular array at a second optical wavelength, and additional sets of signals may be generated by scanning the molecular at additional optical wavelengths. Different signals may be obtained from a molecular array by radiometric scanning to detect radioactive emissions one, two, or more than two different energy levels. Target molecules may be labeled with either a first chromophore that emits light at a first wavelength, or a second chromophore that emits light at a second wavelength. Following hybridization, the molecular array can be scanned at the first wavelength to detect target molecules, labeled with the first chromophore, hybridized to features of the molecular array, and can then be scanned at the second wavelength to detect target molecules, labeled with the second chromophore, hybridized to the features of the molecular array. In one common molecular array system, the first chromophore emits light at a red visible-light wavelength, and the second chromophore emits light at a green, visible-light wavelength. The data set obtained from scanning the molecular array at the red wavelength is referred to as the “red signal,” and the data set obtained from scanning the molecular array at the green wavelength is referred to as the “green signal.” While it is common to use one or two different chromophores, it is possible to use one, three, four, or more than four different chromophores and to scan a molecular array at one, three, four, or more than four wavelengths to produce one, three, four, or more than four data sets.

An array may include any one-, two- or three-dimensional arrangement of addressable regions, or features, each bearing a particular chemical moiety or moieties, such as biopolymers, associated with that region. Any given array substrate may carry one, two, or four or more arrays disposed on a front surface of the substrate. Depending upon the use, any or all of the arrays may be the same or different from one another and each may contain multiple spots or features. A typical array may contain more than ten, more than one hundred, more than one thousand, more ten thousand features, or even more than one hundred thousand features, in an area of less than 20 cm² or even less than 10 cm². For example, square features may have widths, or round feature may have diameters, in the range from a 10 μm to 1.0 cm. In other embodiments each feature may have a width or diameter in the range of 1.0 μm to 1.0 mm, usually 5.0 μm to 500 μm, and more usually 10 μm to 200 μm. Features other than round or square may have area ranges equivalent to that of circular features with the foregoing diameter ranges. At least some, or all, of the features may be of different compositions (for example, when any repeats of each feature composition are excluded the remaining features may account for at least 5%, 10%, or 20% of the total number of features). Interfeature areas are typically, but not necessarily, present. Interfeature areas generally do not carry probe molecules. Such interfeature areas typically are present where the arrays are formed by processes involving drop deposition of reagents, but may not be present when, for example, photolithographic array fabrication processes are used. When present, interfeature areas can be of various sizes and configurations.

Each array may cover an area of less than 100 cm², or even less than 50 cm², 10 cm² or 1 cm². In many embodiments, the substrate carrying the one or more arrays will be shaped generally as a rectangular solid having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. Other shapes are possible, as well. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, a substrate may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays can be fabricated using drop deposition from pulsejets of either polynucleotide precursor units (such as monomers) in the case of in situ fabrication, or the previously obtained polynucleotide. Such methods are described in detail in, for example, U.S. Pat. No. 6,242,266, U.S. Pat. No. 6,232,072, U.S. Pat. No. 6,180,351, U.S. Pat. No. 6,171,797, U.S. Pat No. 6,323,043, U.S. patent application Ser. No. 09/302,898 filed Apr. 30, 1999 by Caren et al., and the references cited therein. Other drop deposition methods can be used for fabrication, as previously described herein. Also, instead of drop deposition methods, photolithographic array fabrication methods may be used. Interfeature areas need not be present, particularly when the arrays are made by photolithographic methods.

As pointed out above, array-based assays can involve other types of biopolymers, synthetic polymers, and other types of chemical entities. A biopolymer is a polymer of one or more types of repeating units. Biopolymers are typically found in biological systems and particularly include polysaccharides, peptides, and polynucleotides, as well as their analogs such as those compounds composed of, or containing, amino acid analogs or non-amino-acid groups, or nucleotide analogs or non-nucleotide groups. This includes polynucleotides in which the conventional backbone has been replaced with a non-naturally occurring or synthetic backbone, and nucleic acids, or synthetic or naturally occurring nucleic-acid analogs, in which one or more of the conventional bases has been replaced with a natural or synthetic group capable of participating in Watson-Crick-type hydrogen bonding interactions. Polynucleotides include single or multiple-stranded configurations, where one or more of the strands may or may not be completely aligned with another. For example, a biopolymer includes DNA, RNA, oligonucleotides, and PNA and other polynucleotides as described in U.S. Pat. No. 5,948,902 and references cited therein, regardless of the source. An oligonucleotide is a nucleotide multimer of about 10 to 100 nucleotides in length, while a polynucleotide includes a nucleotide multimer having any number of nucleotides.

As an example of a non-nucleic-acid-based molecular array, protein antibodies may be attached to features of the array that would bind to soluble labeled antigens in a sample solution. Many other types of chemical assays may be facilitated by array technologies. For example, polysaccharides, glycoproteins, synthetic copolymers, including block copolymers, biopolymer-like polymers with synthetic or derivitized monomers or monomer linkages, and many other types of chemical or biochemical entities may serve as probe and target molecules for array-based analysis. A fundamental principle upon which arrays are based is that of specific recognition, by probe molecules affixed to the array, of target molecules, whether by sequence-mediated binding affinities, binding affinities based on conformational or topological properties of probe and target molecules, or binding affinities based on spatial distribution of electrical charge on the surfaces of target and probe molecules.

Microarrays are often prepared on 1-inch by 3-inch glass substrates, not coincidentally having dimensions of common glass microscope slides. Commercial microarrays are often prepared on smaller substrates that are embedded in plastic housings. FIG. 1 shows a common, currently available commercial microarray packaged within a plastic housing. The microarray substrate, 101 is embedded within the large, rather bulky plastic housing 102 to form an upper transparent cover over an aperture 103 within the plastic housing 102. The features that together compose the microarray are arranged on the inner, or downward surface of the substrate 101, and are thus exposed to a chamber within the plastic housing 102 comprising the microarray substrate 101 and the sides of the aperture 104-107. A transparent bottom cover may be embedded in the lower surface of the plastic housing to seal the chamber in order to create a small reaction vessel into which sample solutions may be introduced for hybridization with molecular species bound to the substrate of the microarray. Thus, the plastic housing serves to package the microarray and protect the microarray from contamination and mechanical damage during handling and storage and may also serve as a reaction chamber in which sample solutions are introduced for hybridization with features of the microarray. The plastic housing may further serve as a support for the microarray during optical or radiometric scanning of the microarray following exposure of the microarray to sample solutions. Scanning may, in certain cases, be carried out through the substrate of the microarray without a need to remove the microarray from the plastic housing.

When using the plastic microarray packaging shown in FIG. 1, it is necessary to seal the substrate of the microarray within the plastic housing to prevent exchange of liquids and vapors between the external environment and the reaction chamber formed by the substrate of the microarray, the plastic housing, and a bottom cover. When microarray substrates made from glass are used, sealants must be carefully selected to seal the glass to plastic without introducing unreacted monomer or producing reactive surfaces that interfere chemically within the hybridization processes that need to be carried out within the reaction vessel. Glass and plastic generally exhibit different thermal expansion behaviors, and care must be taken to avoid creating stresses that may lead to glass-to-plastic bond failures. Plastic packaging may be less mechanically stable than desirable for reliable automated positioning of the microarray within a scanning device. When the embedded microarray is scanned without removing the microarray from the plastic packaging, the thickness of the microarray substrate or of the lower transparent cover, depending from which side of the package the microarray is scanned, must be relatively precisely controlled so that the microarray substrate or bottom cover is not a source of uncontrolled error during the scanning process. Designers, manufacturers, and users of microarrays and microarray packaging therefore have recognized the need for less expensive and more easily handled microarray packaging.

### SUMMARY OF THE INVENTION

One embodiment of the present invention is a microarray package and reaction chamber adapted to a roll-pump application, the microarray package and reaction chamber comprising a pocket, a microarray positioned to substantially cover the pocket, and a flexible cover sealed to the pocket to enclose the microarray in an enclosed package and reaction chamber. The active surface of the microarray, on which features have been deposited, faces into the pocket. In an alternative embodiment, the microarray is positioned active-side down within a reaction chamber with a substantially greater volume than that of reaction fluid introduced into the reaction chamber, and the reaction chamber is rotated so that reaction fluid repeatedly flows across the active surface of the microarray.

A roll pump circulates and mixes solution contained in a gap between the active surface of a microarray positioned within the microarray strip pocket and the bottom, inner surface of the microarray strip pocket. As a microarray strip is rotated about an axis perpendicular to the edges of the microarray strip and in a plane parallel to the broad surfaces of the microarray, solution moves from deep wells into a gap between the active surface of a microarray and the bottom, inner surface of the microarray strip, and, as a result, solution is displaced from the gap to shallow wells. The displaced solution flows from the shallow wells along the inner surface of the cover strip and back to the deep wells as rotation about the axis continues. By continuously rotating the microarray strip, solution is circulated through the gap and mixed within the gap.

### BRIEF DESCRIPTION OF THE DRAWINGS

FIG. 1 shows a common, currently available commercial microarray packaged within a plastic housing.

FIG. 2 shows a microarray strip.

FIG. 3 illustrates an empty pocket within a microarray strip that includes roll pump features.

FIG. 4 shows the pocket illustrated in FIG. 3 following insertion of a microarray.

FIGS. 5A-5B illustrate introduction of a sample solution into a reaction chamber of a microarray strip that includes roll pump features.

FIG. 6 illustrates operation of a roll pump during rotation of a microarray strip reaction chamber.

FIGS. 7A-C illustrate a second, alternate embodiment of a microarray package and reaction chamber suitable for a roll-pump application.

FIG. 8 shows a cut-away view of a completed reaction chamber manufactured according to the process discussed with reference to FIGS. 7A-C.

FIG. 9 illustrates rotation of a reaction chamber, such as the reaction chamber illustrated in FIGS. 7A-C and 8, in a roll-pump application.

FIGS. 10A-C illustrate a third, dispersion-membrane-based alternate embodiment.

FIG. 11 shows a pocket with a regular series of molded, vertical fins directly below the plane of the dispersion membrane.

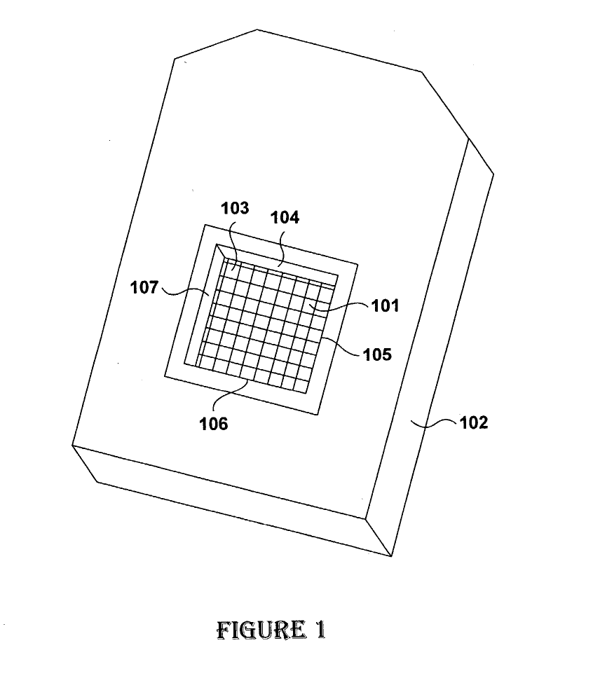

### DETAILED DESCRIPTION OF THE INVENTION

As an approach to developing less expensive and more easily handled microarray packaging, microarray strips have been developed. A microarray strip is a linear sequence of regularly-spaced, tightly sealed reaction chambers that each contains a precisely positioned and oriented microarray. The microarray strip further includes tractor feed perforations or other regularly spaced mechanical or optical features that allow the microarray strip, and the microarray contained within the microarray strip, to be mechanically translated and precisely positioned within various automated electromechanical systems. A microarray strip may also serve as a sequence of economical and reliable storage chambers and as packaging for storing, handling, and transporting microarrays contained within the microarray strip. The microarray strip may be rolled onto drums for compact and reliable storage of microarrays.

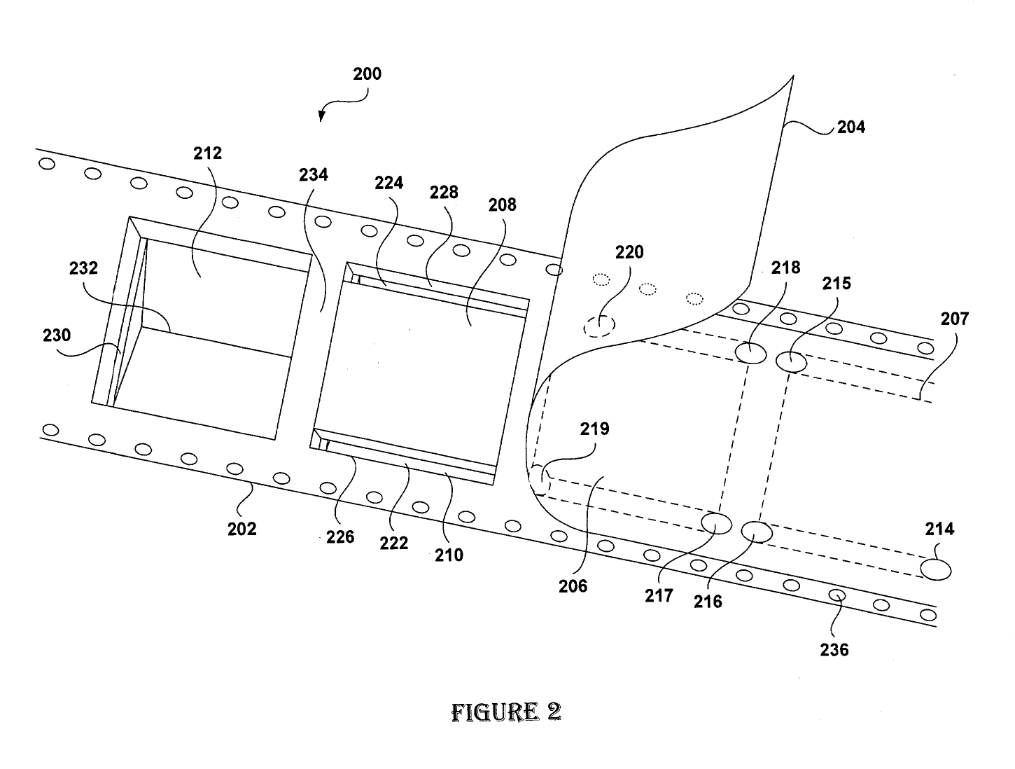

FIG. 2 shows a microarray strip. The microarray strip 200 comprises a pocket strip 202 and cover strip 204. The microarray strip 200 in FIG. 2 is shown during manufacture as the cover strip 204 is being laid down along the top surface of the pocket strip 202 to create sealed reaction chambers 206-207. A microarray 208 has been inserted into a pocket 210 of the pocket strip 202 which will be next covered by the cover strip 204 during the manufacturing process. An additional empty pocket 212, into which a next microarray will be placed, is located to the left of pocket 210 containing microarray 208. Membrane septa 214-220 are affixed to the cover strip 204 over corner regions of the sealed reaction chambers 206 and 207 to provide resealable ports through which solutions can be introduced into, and extracted from, the sealed reaction chambers. The septa are positioned above two elongated wells 222 and 224 formed by gaps between edges of an embedded microarray 208 and the sides of a pocket 226 and 228. Note that each microarray is positioned to rest on two ledges 230 (second ledge obscured in FIG. 2) to leave a gap between the microarray and the bottom 232 of the pocket in which the microarray is placed. The two linear wells 222 and 224 and the gap between the bottom active surface of the microarray and the bottom of the pocket 232 form a single continuous volume within the pocket. The ledges 230 may be designed so that the top surface of the microarray is flush with the upper surface of the pocket strip 234 or, alternatively, may be designed so that the upper surface of the microarray is recessed within each pocket to leave a gap between the upper surface of the microarray and the cover strip 204 following heat sealing of the cover strip 204 to the pocket strip 202. Generally, the active surface of the embedded microarrays, to which features are bonded, is positioned downward, and is opposite from the side of the microarray adjacent to the cover strip in the sealed reaction chambers. Both edges of the pocket strip contain a linear, regularly-spaced sequence of tractor feed perforations such as tractor perforation 236. These perforations can be enmeshed with gear-like feed rollers of various different mechanical systems to allow for automated translation of the microarray strip in a direction parallel to the length of the microarray strip and can also provide for precise mechanical positioning of the embedded microarrays within a scanning device.

Many types of microarray strips can be designed and manufactured, and many different types of materials may be employed. For example, the pocket strip and cover strip may be made from acrylonytrile-butodiene-styrene (“ABS”) plastic and can be continuously manufactured via a vacuform process. The ABS pocket strip and cover strip can be readily heat sealed to provide a reasonably liquid-and-vapor-impermeable barrier. Alternatively, the cover strip may be sealed to the pocket strip via an adhesive sealant or may be designed to allow for mechanical sealing by application of mechanical pressure. Alternatively, both the pocket strip and cover strip may be manufactured from a plastic/metal foil laminate or other materials that provide a more robust barrier to exchange of liquid and vapor between the sealed reaction chambers and the outside environment. The septa can be affixed either to the upper surface or to the lower surface of the cover strip, or can be embedded within the cover strip, and can be manufactured from many different types of materials. One type of septa are three-ply laminates comprising an interior elastomer layer sandwiched between two polyester layers.

Problems can arise in microarray strips due to small gaps between the bottom active surfaces of the microarrays and the bottoms of the pockets that contain them. Because solution in this gap is relatively immobilized by surface tension effects, mixing and circulating solutions within the pockets to thoroughly expose the active surfaces of microarrays to the solutions can be a difficult task. One technique is to introduce air bubbles into the gaps, and move, rotate, or shake the microarray strips to cause the bubbles to move within the gaps. When a bubble moves within a gap, solution is displaced, and mixing occurs. However, bubble movement within the solution is often accompanied by laminar flow within the solution, which, lacking vortices and other solution-mixing phenomena, does not lead to efficient mixing and circulation. More problematic is that the solution conformation of biopolymers can be disrupted at air/solution interfaces, so that the presence of a moving bubble can lead to denaturation of both solvated and bound molecules. This technique is also difficult to apply in a controlled manner, due to difficulties in guaranteeing well-distributed patterns of bubble movement within the gaps.

One embodiment of the present invention is a microarray package and reaction chamber adapted to a roll-pump application or, in other words, microarray package and reaction chamber designed to promote circulation of fluid across the active surface of an enclosed microarray as the microarray package and reaction chamber is rotated. In a described embodiment, the microarray package and reaction chamber include features that together compose a roll pump. The roll pump comprises features molded into the pocket, including two deep vertical wells and two shallow vertical wells that are interconnected with gaps below a microarray positioned within the reaction chamber and between the wells and a cover strip that forms the top of the reaction chamber. As the microarray strip is rotated about a horizontal axis perpendicular to the edges of the microarray strip, solution continuously flows from the deep vertical wells into a gap between the active surface of a microarray and the bottom, inner surface of the reaction chamber, from the gap between the active surface of a microarray and the bottom, inner surface of the reaction chamber into the shallow vertical wells, and from the shallow vertical wells, along the inner surface of the cover strip, back to the deep vertical wells. The continuous flow of solution through the gap between the active surface of a microarray and the bottom, inner surface of the reaction chamber results in circulation and mixing of solution within the gap, thoroughly exposing the active surface of the microarray to the solution contained within the reaction chamber.

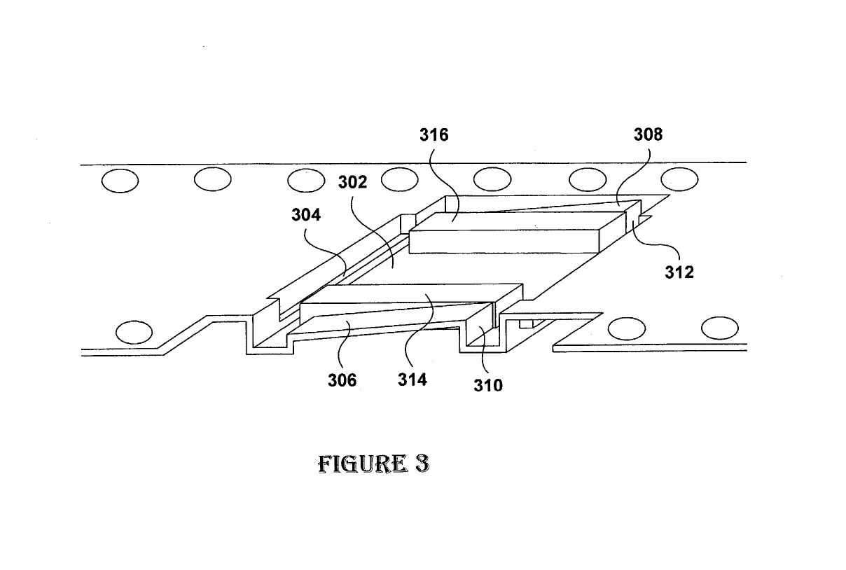

FIG. 3 illustrates a pocket within a microarray strip that includes roll pump features. The pocket 302, shown in a partial cutaway view, includes two ledges 304 (second ledge obscured in FIG. 3) on which the microarray substrate is placed. The pocket additionally contains two ramp features 306 and 308 that each form gutter dams 310 and 312. The ramp features are adjacent to two elongated rectangular box-like features 314 and 316.

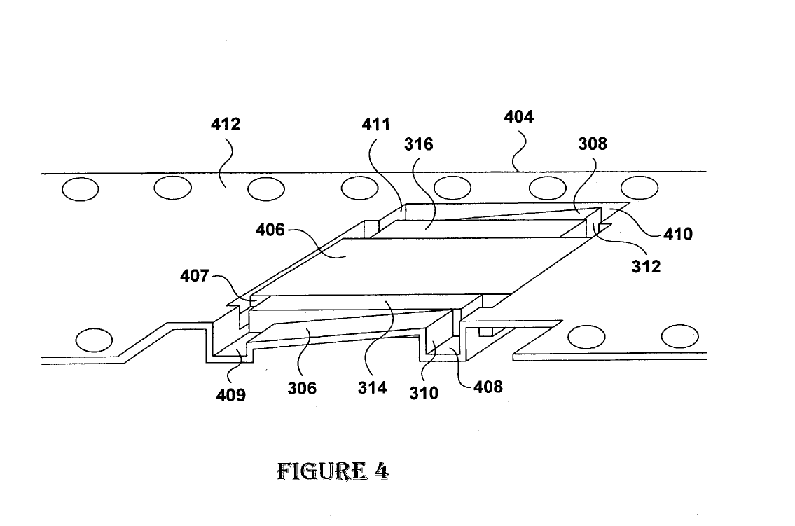

FIG. 4 shows the pocket illustrated in FIG. 3 following insertion of a microarray. In FIG. 4, the microarray 402 has been positioned to rest on top of the ledges (304 in FIG. 3) molded into the sides of the pocket perpendicular to the edge 404 of the pocket strip. The edges of the microarray 406-407 parallel to the edge of the pocket strip 404 are flush with the interior faces of the elongated rectangular features 316 and 314, respectively. A cover strip can be heat sealed or otherwise fastened to the elongated rectangular features 316 and 314 in order to prevent solution from entering a gap between the top surface of the microarray and the cover strip. The ramp features 306 and 308, following insertion of the microarray, provide two vertical wells 408-409 and 410-411 on each side of the microarray 406-407 parallel to the edge of the pocket strip 404. The right-hand vertical wells 408 and 410 are deeper than the shallow, left-hand vertical wells 409 and 411. The depth of the right-hand vertical wells 408 and 410 result from gutter dams 310 and 312, respectively. There are gaps between the bottom surface of the microarray 406 and the bottom of the pocket (302 in FIG. 3) and between the top of the ramp features 306 and 308 and the surface 412 of the pocket strip. Once the cover strip is bound to the surface 412 of the pocket strip, producing an enclosed reaction chamber around the microarray, the vertical wells 408-411, gaps below the bottom surface of the microarray and above the gutter ramps 306-308 form a continuous volume around the microarray substrate.

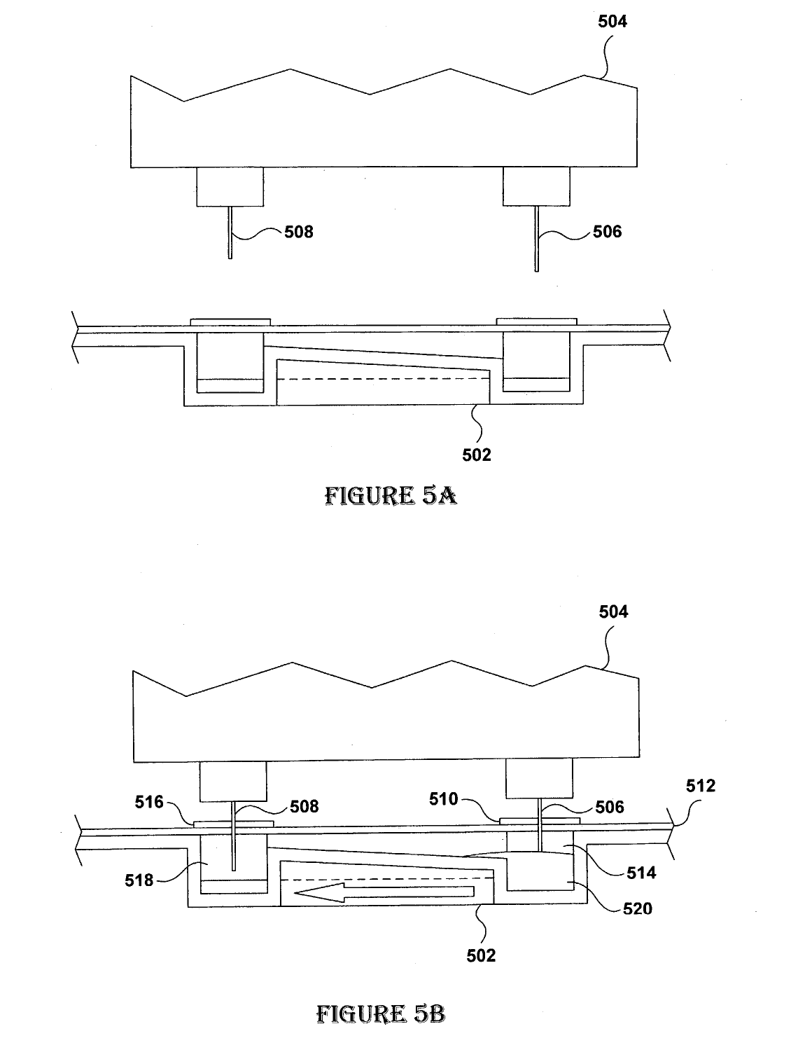

FIGS. 5A-5B illustrate introduction of a sample solution into a reaction chamber of a microarray strip that includes roll pump features. In FIG. 5A, a reaction chamber 502, shown in cross section, is positioned below a sample-introducing machine 504 that includes a pipette tube 506 and a vent tube 508. In FIG. 5B, the sample-introducing machine 504 has been lowered towards the reaction chamber 502 so that the pipette tube 506 has pierced the septum 510 and cover strip 512 directly above a deep vertical well 514 and the vent tube 508 has pierced a septum 516 and a cover strip 512 at a position directly above a shallow vertical well 518. Sample solution 520 has flowed through the pipette tube 506 from the sample-introducing machine 504 into the vertical well 514, and air or liquid displaced by the introduced sample solution 520 has been removed from the reaction chamber 502 via vent tube 508. During automated hybridization processes, the sample-introducing machine 504 may move back and forth between sample vessels or microtitre plates and reaction chambers of a microarray strip positioned via the tractor feed perforations or other alignment features to receive a sample solution from the sample-introducing machine.

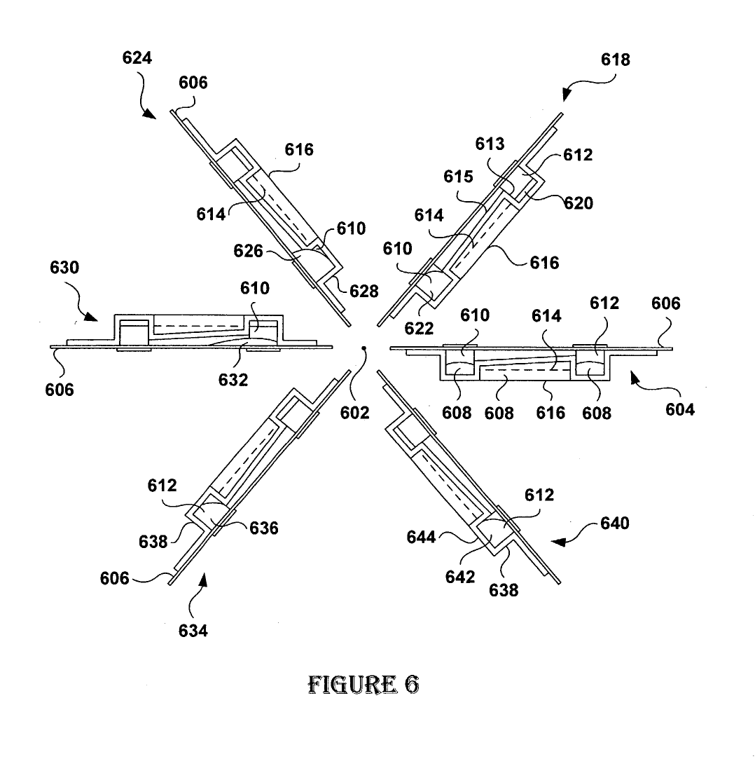

FIG. 6 illustrates operation of the roll pump that represents one embodiment of the present invention. The roll pump operates when a reaction chamber that incorporates roll pump features is rotated about an axis in a plane parallel to the plane of the microarray and perpendicular to the edges of the pocket strip and cover strip of the microarray strip containing the reaction chamber. In FIG. 6, the cross-section of a reaction chamber is shown in six orientations during rotation of the reaction chamber about an axis 602 (shown in cross-section in FIG. 6) in the plane of the cover strip and perpendicular to the edges of the cover strip and pocket strip. The reaction chamber in a first position 604 is level with the cover strip 606 oriented upward. Sample solution 608 is present in both the shallow vertical well 610 and the deep vertical well 612 and underneath the microarray and in contact with the active surface of the microarray. The active surface of the microarray is represented by dotted line 614 in FIG. 6. Sample solution is drawn into and held in the gap between the active surface 614 of the microarray and the bottom 616 of the reaction chamber by capillary action.

The reaction chamber is rotated counterclockwise about horizontal rotation axis 602. At position 618, the reaction chamber is tilted upward, with the deep vertical well 612 higher than the shallow vertical well 610. In this orientation, the sample solution that occupied the deeper vertical well 612 when the reaction chamber was in the first, horizontal position 604 has, for the most part, seeped into the gap between the active surface of the microarray 614 and the bottom of the reaction chamber 616, with sample solution that, in the first horizontal position 604, previously occupied the gap between the active surface of the microarray and the bottom of the reaction chamber, displaced by the sample solution from the deep vertical well into the shallow vertical well 610. Solution is prevented from flowing directly from the deep vertical well 612 to the shallow vertical well 610 by the gutter dam 613 formed from ramp feature 615. Note that, in the first, horizontal position 604, equal volumes of sample solution occupy both vertical wells 610 and 612. However, in the first tilted position 618, only a small amount 620 of sample solution remains in the deeper vertical well 612 while a greater amount 622 of sample solution now occupies the shallow vertical well 610. The solution moves through the gap between the active surface of the microarray and the bottom of the reaction chamber under gravitational force due to the tilting of the reaction chamber. Thus, bulk flow of solution through the gap is effected, although the gap is completely filled with solution during rotation, held in place by surface tension.

As rotation of the reaction chamber in a counterclockwise direction about the horizontal rotation axis 602 continues, the reaction chamber reaches a third, tilted and inverted position 624. In this position, the sample solution 626 occupying the shallow vertical well 610 is resting primarily on a side of the shallow vertical well 628 and on the inner surface of the cover strip 606. Note that, in the third position 624, sample solution remains in the gap between the active surface of the microarray 614 and the bottom of the reaction chamber 616.

As rotation continues about the horizontal axis 602 in a counterclockwise direction, the reaction chamber reaches a fourth, horizontal and inverted position 630. In the fourth position, the sample solution 632, formerly pooled within the shallow vertical well 610, is resting entirely on the inner surface of the cover strip 606. No longer confined within the vertical well 610, the sample solution 632 appears flattened as it spreads out across the surface of the cover strip 606.

As rotation about the horizontal axis 602 continues in a counterclockwise direction, the reaction chamber reaches a fifth position 634 in which the reaction chamber remains inverted and is tilted downward. In this fifth position 634, the droplet of sample solution 636 that rested in the fourth position on the inner surface of the cover strip below the inverted shallow vertical well 610, has flowed downward along the inner surface of the cover strip 606 and pooled in a wedge-shaped volume formed by a side 638 of the deep vertical well 612 and the inner surface of the cover strip 606.

As rotation of the reaction vessel continues in a counterclockwise direction, the reaction vessel reaches a sixth, downward-tilted position 640. In this position, the droplet of sample solution 642 has shifted to occupy a wedge-shaped volume bounded by the bottom surface 644 of the deep vertical well 612 and a side 638 of the deep vertical well.

Finally, as rotation of the reaction vessel continues in a counterclockwise direction about the horizontal axis 602, the reaction vessel returns to the first, level and upright position 604, described above. As the reaction chamber is rotated into this position, pooled sample solution within the deep vertical well 612 flows into the gap between the active surface 614 of the microarray and the bottom 616 of the reaction vessel displacing sample solution from that gap to the shallow vertical well 610.

Thus, following a complete 360° rotation of the reaction vessel about the horizontal rotation axis 602, sample solution has flowed from the vertical well 612 into the space between the active surface of the microarray 614 and the bottom 616 of the reaction vessel, and displaced sample solution from that space has been displaced into the shallow vertical well 610 and has flowed from the shallow vertical well 610 along the inner surface of the cover strip 606 back to the deep vertical well 612. Continuous rotation of a reaction vessel in the fashion illustrated in FIG. 6 produces many cycles of solution exchange between the vertical wells 610 and 612 and the gap between the active surface of the microarray 614 and the bottom of the reaction vessel 616.

A different and more flexible embodiment of a microarray package and reaction chamber than can be used in the roll-pump method, described above, is next described in the following paragraphs. This second, alternate embodiment of a microarray package and reaction chamber can also be manufactured as a microarray strip, described above with reference to FIG. 2. Alternatively, the second, alternate embodiment may be manufactured as discrete, individual reaction chambers that may be linked together into linear strips, or into planar sheets, containing multiple reaction chambers.

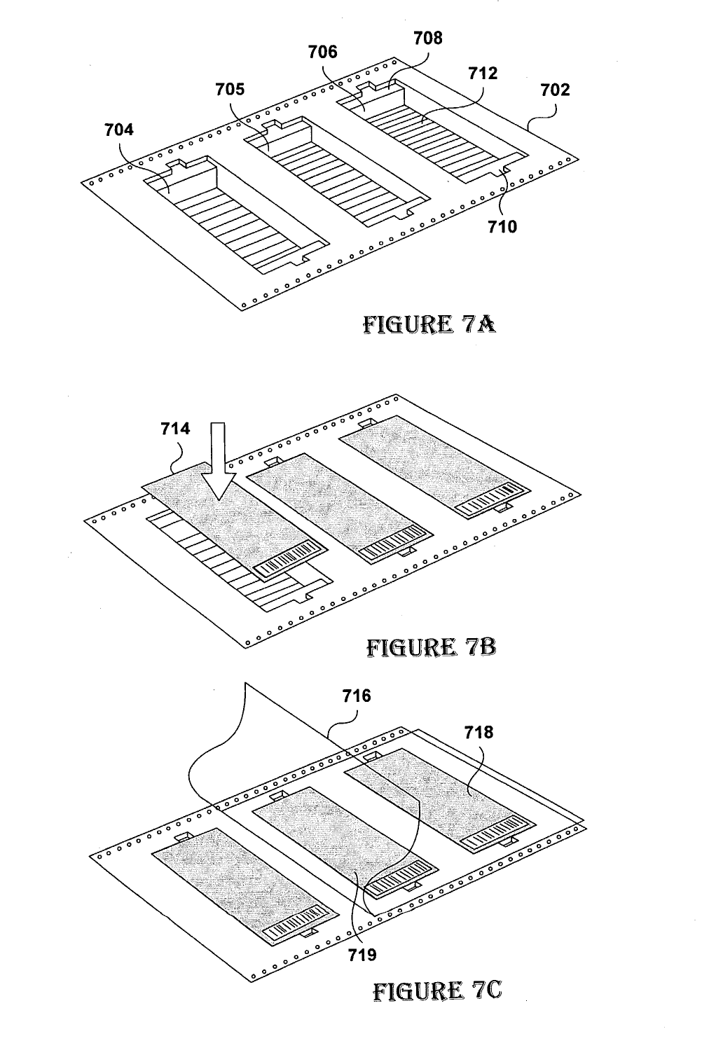

FIGS. 7A-C illustrate the second, alternate embodiment of a microarray package and reaction chamber suitable for a roll-pump application. FIG. 7A shows a short section of pocket strip 702 containing three pockets, or reaction-chamber basins 704-706. In contrast to the pocket shown in FIG. 2, the reaction chambers 704-706 in the second embodiment are significantly larger, and are designed to be only partially filled during reactions directed towards binding labeled molecules to microarray features as well as during wash and preparatory steps. In one embodiment, the reaction chamber may accommodate reaction-fluid volumes of up to three milliliters, although successful reactions, facilitated by rotating the reaction chamber, enclosed microarray, and reaction fluid in order to repeatedly re-expose the microarray to the reaction fluid, can be carried out with reaction-fluid volumes of substantially less than one milliliter. The pockets can be molded or vacu-formed to include step-like rims, such as rim 708, for supporting a microarray, small wells, such as well 710, to facilitate injection of reaction fluids into the reaction chamber, and various patterns and shapes, such as the array of rectangular trays, such as tray 712, in the base of the pocket. In the embodiment shown in FIG. 7A, these rectangular trays serve to stiffen the thin walls of the pocket to enhance structural integrity of the reaction chamber and package. The shapes or patterns may also assist in directing or channeling fluid as the reaction chamber is rotated in a roll-pump application. Additional wells, structures, or protuberances can be formed in the pocket to facilitate placement of septa on cover strips, positioning of microarrays within the pockets, automated sensing, orientation, or manipulation of the reaction chambers, and for other reasons.

FIGS. 7B and 7C illustrate the manufacturing of a complete strip of reaction-chamber-containing microarrays. As shown in FIG. 7B, microarrays, such as microarray 714, are placed active-side, or feature-containing side, downward onto the rims, or supports, molded into the pockets. As shown in FIG. 7C, once the microarrays are positioned within the pocket strip, a flexible cover strip 716 is heat-sealed, or otherwise affixed, to the pocket strip to produce a series of fully enclosed, fluid and vapor impermeable reaction chambers 718 and 719 containing microarrays.

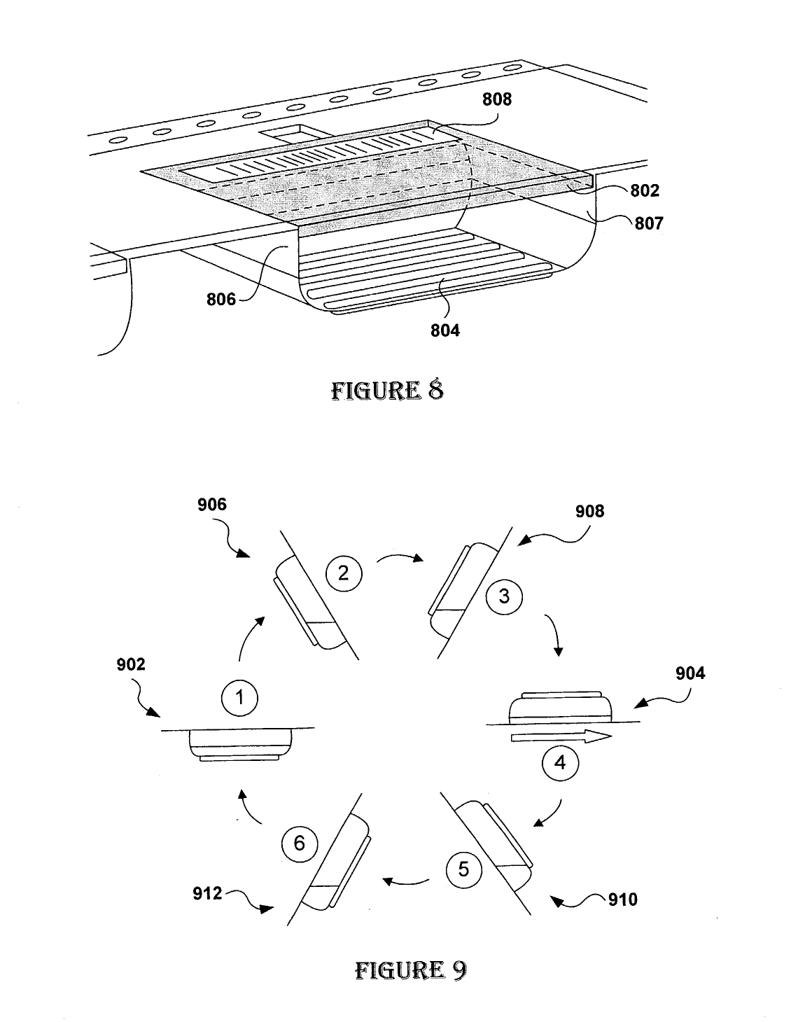

FIG. 8 shows a cut-away view of a reaction chamber manufactured according to the process discussed with reference to FIGS. 7A-C. The microarray 802 is suspended at a relatively large distance above the bottom 804 of the pocket, with the bottom and sides 806-807 of the pocket forming a reaction chamber of large volume below the downward-oriented active face of the microarray. The microarray may includes a barcode 808 encoding useful information, including the type and date of manufacture of the microarray, that can be automatically read during an automated microarray reaction, processing, and data extraction procedure.

FIG. 9 illustrates rotation of a reaction chamber, such as the reaction chamber illustrated in FIGS. 7A-C and 8, in a roll-pump application. As shown in FIG. 9, the reaction chamber may start in a level, upright position 902 and is then rotated to a level, inverted position 904 through a continuous series of angled positions, such as positions 906 and 908. Continued rotation of the reaction chamber through intermediate, angled positions 910 and 912 brings the reaction chamber back to the initial, level, upright position 902. As discussed previously, an entire strip, roll, sheet, or cylinder of microarray-containing reaction chambers can be rolled together about one or more rotation axes in order to continuously mix the reaction fluid and expose the features of the microarray to unreacted components within the reaction fluid. In many applications, the roll-pump operation is conducted both during label-binding reactions as well as during wash steps and other preparatory steps of a multi-step procedure by which the array is prepared for reading or scanning. The large-volume reaction chambers may also be used in alternative rocking or shaking applications that promote mixing of reaction fluids and exposing the microarray to as great a volume of the reaction fluid as possible. Unlike in the first embodiment, described above with reference to FIGS. 3-6, the second, alternate embodiment allows the reaction fluid to flow relatively freely along the bottom and sides of the pockets and interior surface of the microarray. In order to promote fluid mixing and a more even dispersion of fluid across the surface of the microarray, various types of channels, wells, protuberances, and labyrinths may be molded or shaped into the bottom and sides of the pocket.

In a third, alternate embodiment based on the second, alternate embodiment, a distribution membrane positioned close to the active surface of a microarray contained within a reaction chamber can be used to facilitate contact of the surface of the microarray with reaction fluids of quite small volumes. Successful target-binding reactions have been conducted, in this third, alternate embodiment, using reaction fluid volumes of between 30 microliters and 500 microliters. There are a number of advantages to using smaller reaction-fluid volumes, including an ability to use higher concentrations of reactants within the reaction fluids without increasing the amount of reactants used, and compatibility with reaction-fluid volumes of small-volume microtiter-plate wells during automated processing of microarrays.

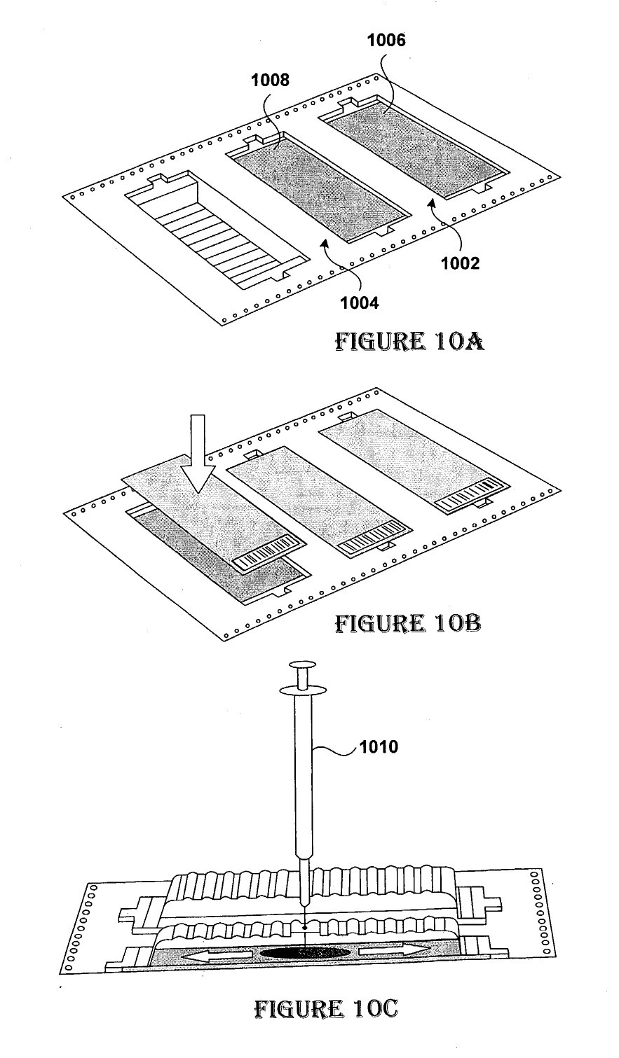

FIGS. 10A-C illustrate the third, dispersion-membrane-based alternate embodiment. In FIG. 10A, two pockets 1002 and 1004 of a three-pocket pocket strip have been covered by thin, tightly stretched dispersion membranes 1006 and 1008, respectively. The dispersion membranes may be made of a variety of different materials, including cellulose acetate, polyether sulfone, micro-perforated polycarbonate films, various types of fabrics, open scrim, and other types of materials that can absorb reaction fluids. In many nucleic acid-based microarray hybridization reactions, water-based reaction fluids are employed, and hence the dispersion membrane is conveniently manufactured from hydrophilic materials, such as those mentioned above. In other types of microarray applications, organic solvents may be employed, and different types of dispersion membrane materials may be used in these applications to absorb the organic solvents. As shown in FIG. 10A, the dispersion membrane is glued, mechanically affixed, or otherwise fastened to the pocket so that it is stretched taughtly over the pocket opening to form a planar surface parallel to, and within 25 to 75 microns of, the downward-oriented, active surface of a microarray placed into the pocket above the dispersion membrane.

FIG. 10B shows placement of microarrays onto rims, or trays, molded into a pocket strip, leaving the active surface of the microarrays very close to the planar surface of attached dispersion membranes. When a small amount of reaction fluid is introduced into the complete reaction chamber, the reaction fluid is absorbed into the dispersion membrane, saturating the dispersion membrane to create a reaction-fluid/dispersion-membrane medium along the active surface of the microarray. In general, dispersion membranes may be on the order of 75 microns thick, so that the dispersion membrane is fully saturated with only a tiny volume of reaction fluid. Excess fluid may be drip into the bottom of the reaction chamber. As the reaction chamber is rolled, the excess fluid pools along one side of the dispersion membrane and enters the reaction-fluid/dispersion-membrane medium as the dispersion membrane rotates from a horizontal to an inclined position. On the opposite side of the dispersion membrane, reaction fluid may seep out of the reaction-fluid/dispersion-membrane medium as the dispersion membrane passes through an inverted, horizontal orientation to a downward inclined position. Thus, as the reaction chamber is rotated, reaction fluid constantly moves through the reaction-fluid/dispersion-membrane medium in order to continuously expose the active surface of the microarray to unreacted reactants in reaction fluid. In many embodiments, as the dispersion membrane becomes saturated with reaction fluid, the reaction-fluid/dispersion-membrane medium adheres through capillary action to the active surface of the microarray, so that the active-surface of the microarray is continuously exposed to the reaction-fluid/dispersion-membrane medium. Because the dispersion membrane is taughtly stretched, and has extremely low mass, contact between the reaction-fluid/dispersion-membrane medium and the active surface of the molecular array does not lead to significant perturbation or damage to the features deposited on the active surface of the microarray. In FIG. 10C, a syringe 1010 has been inserted through the bottom of a reaction-chamber pocket, shown in a cut-away view, and a tiny volume of reaction fluid injected via the syringe directly onto the dispersion membrane. In other embodiments, the reaction fluid may be introduced through the thin cover of the reaction chamber, or by other means.

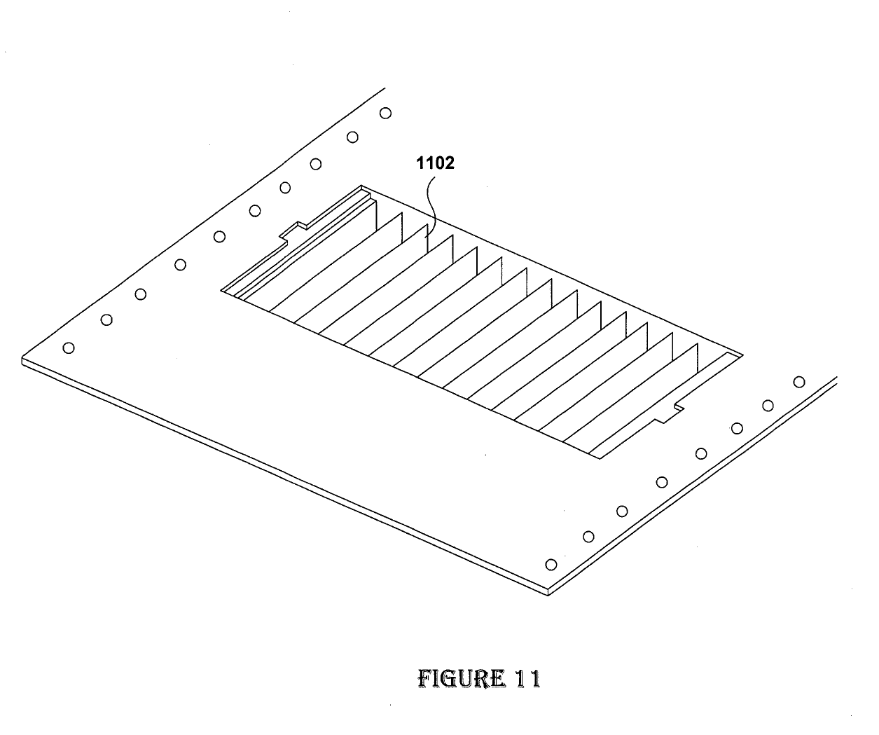

Uniform distribution of reaction fluid within the reaction-fluid/dispersion-membrane medium and uniform flow and exchange of excess reaction-fluid with the reaction-fluid/dispersion-membrane medium may be facilitated by the presence of molded fins or other protuberances below the dispersion membrane within the pocket. FIG. 11 shows a pocket with a regular series of molded, vertical fins directly below the plane of the dispersion membrane. In FIG. 11, each vertical fin, such as vertical fin 1102, rises from the bottom of the pocket to the contact dispersion membrane along a single line at the top of the fin. These vertical fins may serve both to support the dispersion membrane, as well as to direct the flow of reaction fluid across the dispersion membrane as the reaction chamber is rotated about a rotation axis approximately perpendicular to the planes of the vertical fins. The fins thus serve to create channels within the reaction-fluid/dispersion-membrane medium through which reaction fluid flows with less resistance, channeling the reaction fluid uniformly across the entire surface of the dispersion membrane.

The larger-reaction-chamber microarray packages of the second and third alternate embodiments, described above, provide greater flexibility with respect to reaction-fluid volumes than the first-described embodiment. In many applications, these larger-reaction-chamber microarray packages facilitate more efficient fluid recirculation in a roll-pump application. As with all pocket-strip-based microarray packages and reaction chambers, the large-reaction-chamber microarray packages of the second the third embodiments facilitate automation of label-binding and microarray reading or scanning operations, and provide great efficiencies in manufacturing, shipping, and storing microarrays.

Although the present invention has been described in terms of a particular embodiment, it is not intended that the invention be limited to this embodiment. Modifications within the spirit of the invention will be apparent to those skilled in the art. For example, many different constellations of roll pump features may be used to create the deep and shallow vertical wells at opposite ends of each side of the reaction chamber. In an alternate embodiment, no gutter ramp connects the two wells. In still another embodiment, vertical wells may be included along only one side of the reaction vessel, rather than both sides, as shown in the described embodiment. The sizes and shapes of the vertical wells and gap between the active surface of the microarray and bottom of the reaction vessel may vary considerably, and may be selected to accommodate desired volumes of solutions in the vertical wells and in the space between the active surface of the microarray and the bottom of the reaction vessel. In another embodiment, only a single vertical well at one end of the reaction chamber may be included, with displaced sample solution simply pooling around and above the microarray substrate at the opposite end of the reaction chamber. In still another embodiment, two spaces at either end of the reaction chamber, joined via the capillary gap underneath the microarray, and a gap between the microarray and the cover strip may constitute a roll pump. While the inclined-ramp gutter dam feature serves, in the described embodiment, as a type of one-way valve, or channeling mechanism, other types of one-way valves, or channeling mechanisms, may be employed in alternate embodiments to direct solution from one side of the reaction chamber into the capillary gap underneath the microarray. The pocket of a microarray strip including roll pump features may be manufactured from many different types of materials, including synthetic polymers, polymer/metal foil laminates, metals, ceramics, and other materials. Because microarray strips can be conveniently rolled onto reels, the rotation required to activate the roll pumps of reaction chambers within a microarray strip and be applied to a reel containing a rolled-up microarray strip. Although the described embodiment concerned a roll pump incorporated within the reaction chamber of a microarray strip, roll pumps within the scope of the present invention may be employed within other types of microarray packaging and reaction chamber systems, including individual plastic housings. Reaction chambers enclosing other types of reactive entities, other than microarrays, may also include a roll pump according to the present invention. For example, a substrate with a uniform reactive coating or surface may be more effectively exposed to a solution via a roll pump. A roll pump may be included within any enclosed region for circulation of solution within the region. As discussed above, in the third alternate embodiment, many different types of dispersion membrane materials may be employed, and the choice of materials may depend on the nature of the reaction fluids needed to be absorbed by the dispersion membrane. The dispersion membrane may be mechanically affixed to the pocket via molded snaps and clamps, or may be glued, heat sealed, or affixed by other means. The dispersion membrane may cover the entire surface of the microarray, or may, in alternate embodiments, cover only a portion of the surface. In the described embodiment, the dispersion membrane is initially affixed in a position that removes it by 25 to 75 micrometers from the active surface of the microarray, but, in alternative embodiments, the dispersion membrane may be initially in contact with the active surface of the microarray or positioned at other distances from the surface of the microarray. As discussed above, many different types of patterns, shapes, protuberances, wells, and other features may be molded or imprinted on the sides and bottoms of the pockets to facilitate reaction-fluid mixing, the uniform flow of reaction fluid, channeling of reaction fluid, and for other reasons. As discussed above, the roll-pump adapted reaction chambers and packages may be manufactured in continuous strips or sheets, or may be manufactured individually and connected into continuous strips or sheets. The microarray packages of all described embodiments may be manufactured to accommodate microarrays of various sizes and thicknesses, and may be manufactured with materials adapted to the types of molecules deposited on the active surfaces of the microarray and the types of reactants and reaction solutions intended to be employed within the reaction chambers.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A microarray package and reaction chamber adapted to a roll-pump application, the microarray package and reaction chamber comprising:
a pocket;
a microarray positioned to substantially cover the pocket, an active surface of the microarray on which features have been deposited facing into the pocket; and
a flexible cover sealed to the pocket to enclose the microarray in an enclosed package and reaction chamber.

2. The microarray package and reaction chamber adapted to a roll-pump application of claim 1 wherein, as the microarray package and reaction chamber is rotated about an axis, a reaction fluid introduced into the reaction chamber repeatedly flows from the pocket over the active surface of the microarray and back to the pocket.

3. The microarray package and reaction chamber adapted to a roll-pump application of claim 1 further including a dispersion membrane mounted co-planar with, and below the active surface of, the microarray.

4. The microarray package and reaction chamber adapted to a roll-pump application of claim 3 wherein the dispersion membrane comprises a material that absorbs a reaction fluid introduced into the reaction chamber and thereby maintains a reaction-fluid/dispersion-membrane medium in contact with the active surface of the microarray.

5. The microarray package and reaction chamber adapted to a roll-pump application of claim 4 wherein features are molded or imprinted on the pocket to facilitate uniform flow of reaction fluid through the reaction-fluid/dispersion-membrane medium.

6. The microarray package and reaction chamber adapted to a roll-pump application of claim 1 wherein features are molded or imprinted on the pocket to facilitate uniform flow of reaction fluid over the active surface of the microarray.

7. The microarray package and reaction chamber adapted to a roll-pump application of claim 1 wherein features are molded or imprinted on the pocket to facilitate mixing of reaction fluid within the reaction chamber.

8. A number of microarray packages and reaction chambers adapted to a roll-pump application of claim 1 manufactured as a strip of microarray packages and reaction chambers.

9. A number of microarray packages and reaction chambers adapted to a roll-pump application of claim 1 manufactured as a 2-dimensional sheet of microarray packages and reaction chambers.

10. A method for circulating and mixing solution within a microarray package and reaction chamber, the method comprising:
providing a microarray package and reaction chamber comprising a pocket, a microarray positioned to substantially cover the pocket, an active surface of the microarray on which features have been deposited facing into the pocket, and a flexible cover sealed to the pocket to enclose the microarray in an enclosed package and reaction chamber;
introducing solution into the reaction chamber; and
rotating the reaction chamber so that solution repeatedly flows from the pocket across the active surface of the microarray and back into the pocket.

11. A method for circulating and mixing solution within a microarray package and reaction chamber, the method comprising:
providing a microarray package and reaction chamber comprising a pocket, a microarray positioned to substantially cover the pocket, an active surface of the microarray on which features have been deposited facing into the pocket, a dispersion membrane mounted parallel to, and in close proximity with, the active surface of the microarray, and a flexible cover sealed to the pocket to enclose the microarray in an enclosed package and reaction chamber;
introducing solution into the reaction chamber; and
rotating the reaction chamber so that solution repeatedly flows from the pocket into a reaction-fluid/dispersion-membrane medium in contact with the active surface of the microarray and back into the pocket.

12. A microarray exposure facilitator used in microarray package and reaction chambers to facilitate exposure of a surface of a microarray substrate to small-volume solutions, the microarray exposure facilitator comprising:
a microarray, positioned within a pocket of the microarray package and reaction chamber, having an active surface; and
a dispersion membrane affixed within the pocket of the microarray package and reaction chamber parallel to, and in close proximity of, the active surface of the microarray.

13. The microarray exposure facilitator of claim 12 comprising a thin sheet of one of:
cellulose acetate;
polyether sulfone;
micro-perforated polycarbonate film;
fabric; and
open scrim.

14. The microarray exposure facilitator of claim 12 comprising a thin sheet of material that absorbs one or more solutions to which the microarray is exposed.

15. A method for exposing a surface of a microarray substrate, enclosed within a microarray package and reaction chamber, to small-volume solutions, the method comprising:
affixing a dispersion membrane within the pocket of the microarray package and reaction chamber; and
positioning an active side of a microarray within the pocket of the microarray package and reaction chamber parallel to, and in close proximity to, the dispersion membrane.
